(19) United States
(12) Patent Application Publication
(10) Pub. No.: US 2002/0144158 A1
(43) Pub. Date: Oct. 3, 2002

(54) Time domain sensitive password protection (TDSPP)

(76) Inventor: Christopher Hekimian, Gaithersburg, MD (US)

Correspondence Address: Howard L. Rose, Suite 311, 1001 North Federal Highway, Hallandale, FL, 33009, US

(21) Appl. No.: 09/819,206

(22) Filed: Mar. 29, 2001

(51) Int. Cl. H04L 9/32

(52) U.S. Cl. 713/202

(57) ABSTRACT

A time domain password protection system comprises a password of various letters that must be entered at specific clock times to have the password recognized as valid.

### FIELD OF THE INVENTION

The present invention relates to password protection of computer information, and more particularly, to a password protection system rendering hacking extremely difficult and time consuming.

### BACKGROUND OF THE INVENTION

Current computer and ATM password techniques rely on the matching, letter by letter, of an entered password to a one to one mapped codeword stored in the controlling computers memory. This type of password protection is vulnerable to common computer hacking utilities that simply iterate through all possible password combinations.

Password protection methods are commonly used for controlling access to individual computer programs or databases, to networks and network (and internet) based assets, and as a means of distribution control for software providers so that use of their products can be restricted to their paying customers. In each of these applications, information resources are withheld from a potential user until the user provides proof of identity by entering a word or string of characters or a phrase that presumably, would be known only to the specified, authorized user.

Password authentication techniques have been in widespread use in computer software and computerized equipment for as long as digital computers have been in existence. The ease of implementation of password systems and their potential to be reasonably effective have made them the most popular means of identity verification for purposes of system of information access authentication. However, as the speed and capabilities of computers have increased, password protected systems have been increasingly vulnerable to challenges in the following three forms:

1. Dictionary attacks, where a hostile computer program will attempt to find a password by exhaustively attempting all words in a huge list or dictionary.

2. Sniffer attacks, where a communication line is monitored by a hostile computer program and data is scanned and analyzed for identifiable password sequences.

3. Personnel and garbage attacks, where an attempt is made to trick a person into revealing a password, or some physical type of penetration effort is made in order to find a password.

In order to meet the challenges imposed by the hostile measures listed above, existing password authentication techniques have been enhanced to include combinations of any of the following variations on the basis theme of requiring a user to prove identity by producing a character sequence (password) that ostensibly, would be known only to that person.

a. Unnatural passwords are often used that include special characters and mixed case letters.

b. Two or more words appended together.

c. Periodically changing passwords.

d. Single-use passwords.

e. Challenge and response techniques.

f. Encrypted passwords.

### BRIEF DESCRIPTION OF THE INVENTION

The present invention is hereinafter referred to as the TDSPP system or password protection scheme. The invention lends itself to any purpose that is currently served by a password access control method. TDSPP provides a means of protecting individual computer programs and software applications, computer networks, distributed network resources or web sites, databases, on line services, touch tone (telephone) accessible services and even physical system access control such as might be employed in a secure door opener or a part of a bank vault lock system.

The present invention, is at variance with the basic theme of existing password techniques due to one distinguishing characteristic. The new system adds the element of time sensitivity. Time sensitivity password systems, as presented here, are virtually immune to dictionary attacks and to all but the most sophisticated sniffer attacks. Depending on the extent to which a password might be compromised through a personnel or garbage attack, the new system may withstand many of those attacks too.

The present technique (Time Domain Sensitive Password Protection) takes an important step towards defeating the password “cracker” attack. The present technique involves a password that is time domain sensitive, i.e., not only must the password be correct, but the time delay between the entry of the successive characters of the password must be exact or “close enough” to the pattern of delays established by the authorized user. While a human can easily enter a password with a specified rhythm, or use a specified delay between keystrokes, the burden placed upon password cracker programs is tremendous.

Using a prototype system and the simple example of a 4 digit ATM password, with delays not exceeding 10 seconds per digit, a password cracker program would have an additional 25³=15,625 (alphabet) combinations to try, even if the password itself was known by the intruder. The TDSPP system can be configured in a number of ways. Some configurations would require a password cracker program to carry out thousands of additional attempts, each taking several seconds to complete. For our example it is quite conceivable that it would typically take over 24 hours in order to crack a 4 digit password, even if the password itself was known by the intruder. Of course, most passwords contain more than 4 digits and are kept secret.

The current technique provides significant advantage over other password authentication techniques. The advantages include:

1. Significant defense against password cracking programs due to increased combinations,

2. Significant defense against password cracking programs due to time required to conform,

3. Significant defense against human password compromise vulnerabilities,

4. Significant defense against password snooping,

5. The ability to quickly and easily change the time between and the digits themselves.

As an extremely simple example of the present invention, the characters are A through F, in order, will represent the textual portion of a time domain sensitive password, and the time period in which the time sensitive portion of the password has been established will be the first six seconds following the entry of the first character inputted into the keyboard. Thus, “B” might be chosen to occur in the first or last half of the second following input of the first character, the next character “C” might be chosen to be entered in the last or first half of the second and so on. The time of the keyboard entries and the length of time available for entry may also vary. Using a six character password, and 100 different possible time slots for single case letters of the alphabet, the number of combinations is vast and exceeds 1×10¹⁵, more than 3 million times the number of combinations that would exist without time domain sensitivity. Furthermore, though high speed computers would be capable of resolving trillions of more password combinations in a matter of hours, the use of time domain sensitivity, where each password attempt would require just six seconds to enter, the time required to crack the password would be astronimical and would exceed millions of years.

The matter may be rendered additionally difficult by inserting dummy characters, case sensitivity, or standard characters, such as an asterisk, exclamation point, comma, etc.

The submitted password characters are accumulated in a memory location on a time sensitive basis relative to a pre-specified time pattern. The time pattern of FIG. 2 continues until the 6th time slot from initial (closure) has occurred. At this time the system senses that all password character slots have been filled and no further characters are accepted. At least two algorithms for imparting time sensitivity to the password entry process are presented. One method involves the time gating of the keyboard or input device in a manner that will only accept inputted characters during brief time periods defined by the known password which has been gated in according to the specified time pattern is simply compared with the known password on the receiver side for authentication to be complete.

Another technique involves the recording of the time relative to the input of the first character of the submitted password in a separate memory location and making comparisons on both the textual and time domain portions of the password independently on the side of the receiver. The end of the password could be signified by a carriage return or the closure of an “enter” key. The collected password and time key vector could be transmitted to the server in a conventional manner so they can be compared with the known password.

Both of these techniques have advantages and disadvantages over each other that are discussed in greater detail in a later section. Factors to be considered are convenience and security desired, the closeness of the match between the known time key vector and the time key vector received by the client or the duration of keyboard windows of character acceptance. These factors would be easily controlled by the administrator of the system. Depending on the technique chosen for implementation of TDSPP, different measures can be taken to further enhance the security of the system to their types of attacks. For example, for a remote application of the first technique that was discussed, the use of randomly inserted characters during keyboard null periods would be a potent deterrent to even an unusually powerful sniffer program.

The above and other features, objects and advantages of the present invention, together with the best means contemplated by the inventor thereof for carrying out the invention will become more apparent from reading the following description of a preferred embodiment and perusing the associated drawings in which:

### BRIEF DESCRIPTION OF THE DRAWINGS

FIG. 1 illustrates the basic components of a time domain sensitive password to be discussed and analyzed;

FIG. 2 is a timing diagram defining the time sensitive component of the password of FIG. 1;

FIG. 3 is a system block diagram of one form of the invention;

FIG. 4 is a diagram of an alternative form of the invention to the FIG. 3 structure; and

FIG. 5 is a block diagram illustrating a sending and receiving system employing TDSPP.

### DETAILED DESCRIPTION OF THE PRESENT INVENTION

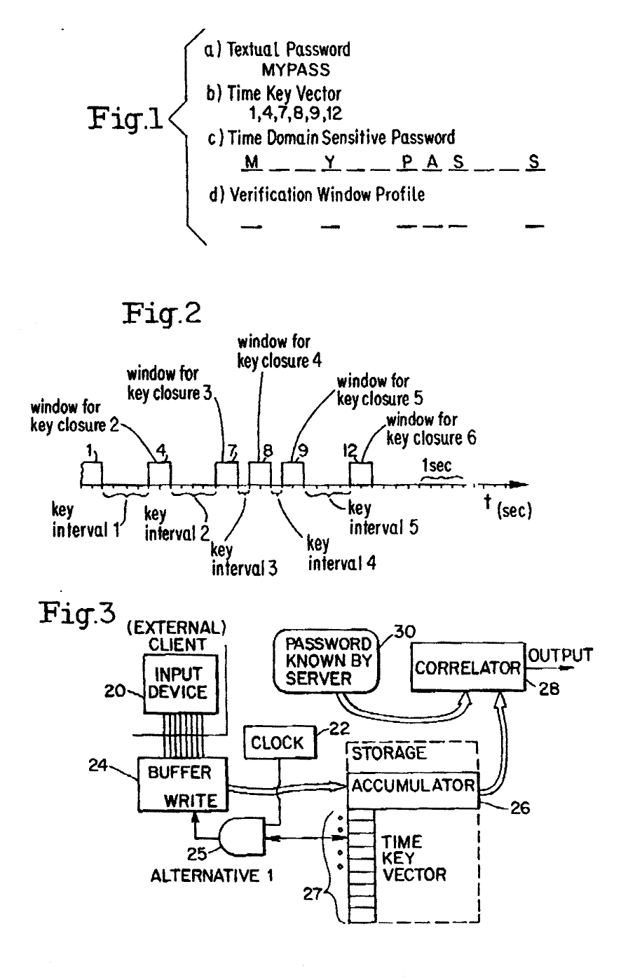

Referring now to FIG. 1, a time domain sensitive password with the textual component “MYPASS” is analyzed. Line (b) illustrates the time key vector of the password. The elements of the time key vector are measured in units of time relative to the first key closure of the password entry sequence. The temporal location in time of the password characters of this example is illustrated in line (c) of the figure, which coupled with the time diagram of FIG. 2 provides a clear picture of the timing characteristics of the password that must be obeyed. For the preferred system implementation, at times 2, 6, 10, 12, 14 and 18 characters may be entered and recognized. At other times characters may be entered, but they won't be recognized as part of this password. For the alternate implementation, each password character will be recognized along with the clock count corresponding to its time of entry as measured relative to the first characters time of admission. The received textual password and the corresponding measured time key vector would be compared to the master versions known by the secure system.

Referring specifically to FIG. 3 of the accompanying drawings, an operator located at a keyboard 20 may enter the password characters by striking each key of the code at specified times. The appropriate timing may be easily established based upon the rhythm of a song known by the operator. Between each timing interval, as determined by clock 22, the operator may strike a key or not. In the pattern of the present invention at time “t=1 the operator may enter character “M”. Using the song, “If I had the wings of an Angel” he would strike the “M” 2 at time of key closure 2, see FIGS. 1 and 2. Character “Y” is next entered at time 6 and so on until key closure 18. Of course, the operator must remember his cadence (he may use a metronome to insure that each of the 6 characters are entered at their appropriate times. This cadence must be known by the authenticating entity at the receiving end.

Relating this information specifically to the structure of FIG. 3, a keyboard 20, for instance, is connected to a clock 22 driven buffer 24 via a lead for each bit of the character to be entered. As the system clock starts its count, the clock count is compared to the first value stored in the key time vector 27. Only if the two values are the same will the contents of the buffer 24 be copied to the accumulator portion of system memory 26. The count of the system clock 22 continues and each successive character input from input device 20 is conveyed to the accumulator portion of memory 26 via the buffer 24 in accordance with the appropriate time values stored in the time key vector portion of memory 27. In effect, the clock 22 and known time key vector 27 are logically “anded” gate 24 and the result of the operation controls the write function of the buffer 24 to permit entry of the inputted character into the accumulator 26. Upon the accumulator 26 receiving six characters (in this example) the accumulator outputs the pertinent information to a correlator 28 that compares such output and the password in element 30 known to the receiver. If they match, the password is authorized, if not, a match is not authorized.

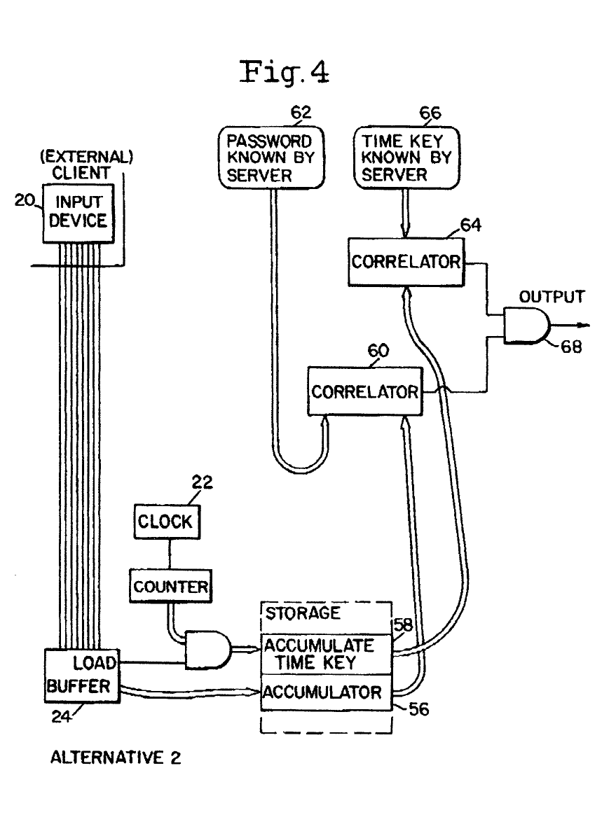

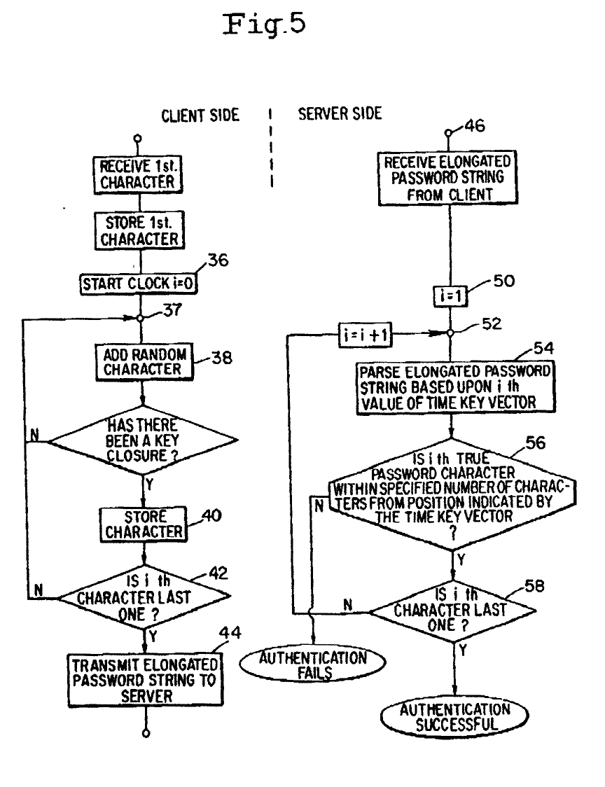

In a second embodiment of the invention as illustrated in FIG. 4, the characters of the password and relative time from the time of entry of the first character from input device 20 as measured by the system clock 22 are processed and investigated separately. The characters are stored in an accumulator 56. The time information is stored in another memory location which functions as an accumulator for the time key 58. With the entry of each character from the input device 20, the buffer 24 contents are conveyed to the accumulator 56. The count of the clock driver counter 22 is conveyed to the accumulator 58. The count of the clock driven counter 26 is conveyed at the same instant (time of buffer 24 write to accumulator 56) to the time key accumulator 58. This process is similar to the function of a logical AND operation where the clock driven counter 26 contents are written to the time key accumulator 58 only when a buffer 24 load operation from the input device 20 is taking place. After the last character of the password has been entered and it has been appended to the contents of accumulator 56 and the clock driven counter contents have been stored in the time key accumulator 58, the outputs of the two accumulators are fed to correlator 60 where they are compared with the known password supplied from element 62. The time factor is compared in correlator 64, and together with correlator 60 which determines characters, the authentication output function is, in effect, a logical AND operation which is represented by logic Gate 68.

The block diagram shown in FIG. 5 depicts a practical implementation of a pseudo real time TDSPP system involving client and server network entities. On the client side the technique involves the inclusion of randomly generated characters, at a regular time interval, between authentic characters that are input from the client keyboard at irregular time intervals. After the last password character is input from the keyboard and an “enter” key closure or a carriage return is detected, the elongated string consisting of random characters, interspersed between authentic characters will be transmitted to the server side for authentication. The resulting randomized and elongated string effectively contains the time component of the time domain sensitive password as each character represents unit of time elapsed.

More specifically, the first character “i”=1, is stored in the password accumulating memory area. At this time the system clock 36 is started. With the next clock cycle a random character is appended to the string containing the “i^{the}” character. This process is continued until another character is received, as detected by a key closure. When a key closure is detected, the received character is appended to the string containing the authentic and randomly generated characters. Only after the last password character has been received, as denoted by receipt of a termination character such as a carriage return, is the elongated password string transmitted to the server.

On the server side of the elongated password string the string must be processed. Referring to point 46 on the diagram, the first character would be accepted as the first character of the textual portion of the time domain sensitive password. The next step of the password reconstruction is to skip the number of characters, but in practice it might be the case that the actual password character might be just within close proximity to the currently indicated character. The system can be configured to look for the expected character within a specified number of characters from the indicated character 56. The process of parsing the elongated strong based upon the stored time key vector and determining whether the known password character is within the specified number of characters of either side of the indicated character is continued until the end of the elongated string is encountered, and authentication is declared successful or until the comparison made in block 56 fails to match, in which case authentication fails immediately.

The use of the elongated, randomly generated carrier string makes this technique resistant against most password sniffer programs.

Once given the above disclosure, many other features, modifications and improvements will become apparent to the skilled artisan. Such features, modifications and improvements are, therefore, considered to be a part of this invention, the scope of which is to be determined by the following claims.

What is claimed is:

1. A method of producing a time and digit dependent password comprising
the steps of sending a string of digits including at specific time locations digits when compiled defining a specific password,
compiling the digits appearing at the specific time locations into a continuous unspaced group of digits, and
producing a recognizable signal upon the compiled group of digits matching the specific password.

2. A time and digit dependent password system comprising
means for transmitting a string of digits having at specified times digits when assembled as adjacent members of a string of digits, satisfy said password,
means for extracting from the string of digits at specified times the digits of the password,
means for assembling the digits into adjacent digits of a strong of digits, and
means for producing a signal when the adjacent digits of the string correspond to the digits of the password.

3. A password transmitted system comprising
a password employing characters,
means for entering each character,
said password requiring each character to be entered into the system at specified time relative to entry of a first character of the characters to cause the password to be accepted.

4. A password transmitted system according to claim 3, further comprising
an accumulator,
a clock,
said clock allowing entry of characters into said accumulator only at specified times as determined by the sequence of the characters in the password.
